(19) United States
(12) Patent Application Publication
(10) Pub. No.: US 2026/0253916 A1
(43) Pub. Date: Aug. 27, 2026

(54) FUEL CELLS HAVING A SEGMENTED CONSTRUCTION FOR MITIGATING AIR-AIR START DEGRADATION

(71) Applicant: Robert Bosch GmbH, Stuttgart (DE)

(72) Inventors: Bjoern STUEHMEIER, Santa Clara, CA (US); Jonathan BRAATEN, Sunnyvale, CA (US); Lei CHENG, Sunnyvale, CA (US); Alexander VAN-BRUNT, Sunnyvale, CA (US); Shirin MEHRAZI, San Jose, CA (US); Felipe MOJICA, Santa Clara, CA (US)

(21) Appl. No.: 19/064,421

(22) Filed: Feb. 26, 2025

(51) Int. Cl. H01M 8/0258; H01M 4/86; H01M 8/0202; H01M 8/10

(52) U.S. Cl. CPC H01M 8/0258; H01M 4/86; H01M 8/0269; H01M 8/10; H01M 2004/8684; H01M 2008/1095

(57) ABSTRACT

A fuel cell (e.g., a proton exchange membrane fuel cell) is disclosed includes a cathode electrode, an anode electrode, a membrane extending between the cathode electrode and the anode electrode, a cathode gas diffusion layer (GDL), a cathode flow field, an anode GDL, and an anode flow field. The anode flow field is segmented by one or more separations to form a plurality of electrically isolated segments to mitigate polarization during an air-air start of the fuel cell.

### TECHNICAL FIELD

The present disclosure relates to fuel cells (e.g., proton exchange membrane fuel cells) having segmented constructions for mitigating air-air start degradation.

### BACKGROUND

One type of electrochemical cell is a device capable of generating electrical energy from chemical reactions (e.g., fuel cells). Fuel cells have shown promise as an alternative power source for vehicles and other transportation applications. Fuel cells operate with a renewable energy carrier, such as hydrogen. Fuel cells also operate without toxic emissions or greenhouse gases. An individual fuel cell includes a membrane electrode assembly (MEA) and two flow field plates. An individual fuel cell typically delivers 0.5 to 1.0 V. Individual fuel cells can be stacked together to form a fuel cell stack having higher voltage and power.

### SUMMARY

In one or more embodiments, a fuel cell (e.g., a proton exchange membrane fuel cell) is disclosed. The fuel cell includes a cathode electrode, an anode electrode, a membrane extending between the cathode electrode and the anode electrode, a cathode gas diffusion layer (GDL), a cathode flow field, an anode GDL, and an anode flow field. The anode flow field includes an anode flow field channel having an anode flow field channel surface. The anode flow field is segmented by one or more separators of the anode flow field channel to form a plurality of electrically isolated segments to mitigate polarization during an air-air start of the fuel cell.

In another embodiment, a fuel cell is disclosed. The fuel cell includes a cathode electrode, an anode electrode, a membrane extending between the cathode electrode and the anode electrode, a cathode flow field, a cathode GDL, an anode flow field, and an anode GDL. The anode GDL has an electrically isolating structure to mitigate polarization during an air-air start of the fuel cell.

In yet another embodiment, a fuel cell is disclosed. The fuel cell includes a cathode electrode, an anode electrode, a membrane extending between the cathode electrode and the anode electrode, a cathode flow field, a cathode GDL, an anode flow field, and an anode GDL. The anode electrode has first regions and second regions different than the first regions to form a plurality of electrically isolated segments to mitigate polarization during an air-air start of the fuel cell.

In a further embodiment, a fuel cell stack is disclosed. The fuel cell stack includes a first fuel cell including a first cathode electrode, a first anode electrode, a first membrane extending between the first cathode electrode and the first anode electrode, a first cathode GDL, a first cathode flow field, a first anode GDL, and a first anode flow field. The fuel cell stack includes a second fuel cell including a second cathode electrode, a second anode electrode, a second membrane extending between the second cathode electrode and the second anode electrode, a second cathode GDL, a second anode GDL, and a second anode flow field adjacent to the first cathode flow field. The second anode flow field and the first cathode flow field collectively form an integrated bipolar plate segmented by one or more segmentations extending at least a portion of the second anode flow field and the first cathode flow field to form a plurality of electrically isolated segments to mitigate polarization during an air-air start of the fuel cell.

### BRIEF DESCRIPTION OF THE DRAWINGS

FIG. 1 is a schematic, side view of certain components of a prior art proton exchange membrane fuel cell (PEMFC).

FIG. 2 is a schematic, side view of the prior art PEMFC conceptually separated into a fuel cell segment and an electrolytic cell segment.

FIG. 3 depicts a schematic, side view of a PEMFC having a segmented flow field according to one embodiment.

FIG. 4 is a graph of normalized electrochemical surface area (nECSA) as a function of start-up cycles for different local residence times (i.e., 0.1 seconds, 0.3 seconds, and 0.5 seconds).

FIG. 5 depicts a schematic view of a PEMFC including segmented anode flow fields forming anode flow field segments and segmented GDLs forming GDL segments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. These terms may be used to modify any numeric value disclosed or claimed herein. Generally, the term “about” denoting a certain value is intended to denote a range within ±5% of the value. As one example, the phrase “about 100” denotes a range of 100±5, i.e., the range from 95 to 105. Generally, when the term “about” is used, it can be expected that similar results or effects according to the invention can be obtained within a range of ±5% of the indicated value. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1 to 10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

As used herein, the term “and/or” means that either all or only one of the elements of said group may be present. For example, “A and/or B” means “only A, or only B, or both A and B”. In the case of “only A”, the term also covers the possibility that B is absent, i.e., “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description and does not necessarily preclude chemical interactions among constituents of the mixture once mixed. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

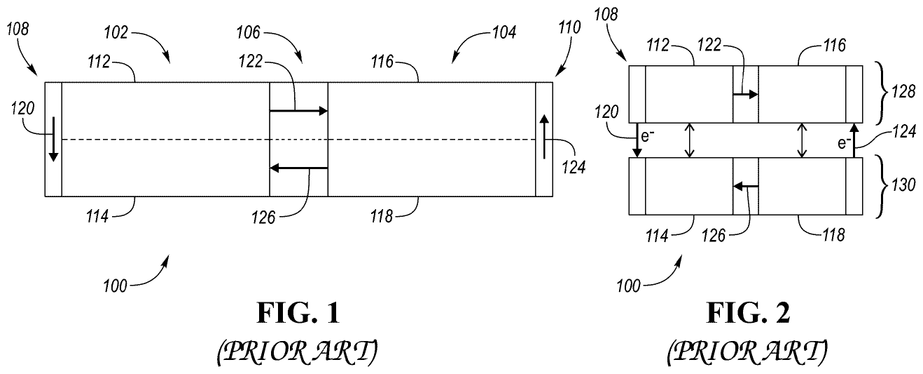

FIG. 1 is a schematic, side view of certain components of a prior art proton exchange membrane fuel cell (PEMFC) 100. As shown in FIG. 1, PEMFC 100 includes anode compartment 102 including an anode catalyst support at least partially coated with an anode catalyst material and cathode compartment 104 including a cathode catalyst support at least partially coated with a cathode catalyst material. Polymer electrolyte material (PEM) 106 extends between anode compartment 102 and cathode compartment 104. Fuel cell 100 also includes first and second flow fields 108 and 110. Fuel cell 100 also includes first and second gas diffusion layers (GDLs).

FIG. 1 is associated with a start-up and/or shut-down (SUSD) event in a PEMFC. During a SUSD event, a H₂/air front passes through an anode flow-field (including H₂-filled region 112 and air-filled region 114) while the cathode flow field is filled with air with air-filled regions 116 and 118. During an SUSD event, the following hydrogen oxidation reaction (HOR) occurs in H₂-filled region 112 of anode compartment 102:

$$2 {H}_{2} \to 4 {e}^{-} + 4 {H}^{+} \qquad ( 1 )$$

During an SUSD event, the following oxygen reduction reaction (ORR) occurs in air-filled region 114 of anode compartment 102:

$$4 {H}^{+} + {O}_{2} + 4 {e}^{-} \to 2 {H}_{2} O \qquad ( 2 )$$

The pathway of electrons through anode compartment 102 and the first GDL on the anode side is represented by arrow 120. As shown by arrow 122, protons pass through PEM 106 into cathode compartment 104.

During an SUSD event, the following oxygen reduction reaction (ORR) occurs in air-filled region 116 of cathode compartment 104:

$$4 {H}^{+} + {O}_{2} + 4 {e}^{-} \to 2 {H}_{2} O \qquad ( 3 )$$

During an SUSD event, the following carbon corrosion reaction (COR) and oxygen evolution reaction (OER) occurs in air-filled region 118 of cathode compartment 104:

$$C + 2 {H}_{2} O \to 4 {e}^{-} + 4 {H}^{+} + {CO}_{2} \qquad ( 4 )$$

$$2 {H}_{2} O \to 4 {e}^{-} + 4 {H}^{+} + {O}_{2} \qquad ( 5 )$$

The pathway of electrons through cathode compartment 104, second flow field 110, and the second GDL on the cathode side is represented by arrow 124. As shown by arrow 126, protons pass through PEM 106 into anode compartment 102. In-plane proton conduction is only possible within very short distances from the H₂/air front (e.g., about 120 μm or less for a 20 μm thick membrane) and not over extended distances.

FIG. 2 is a schematic, side view of the prior art PEMFC 100 conceptually separated into fuel cell segment 128 and electrolytic cell segment 130. The hydrogen oxidation reaction (HOR) occurring in H₂-filled region 112 of fuel cell segment 128 may have a voltage reference of about 0.00 VRHE. The oxygen reduction reaction (ORR) occurring in air-filled region 116 of fuel cell segment 128 may have a voltage reference of about 0.84 VRHE. The oxygen reduction reaction (ORR) occurring in air-filled region 114 of electrolytic cell segment 130 may have a voltage reference of about 0.60 VRHE. The combined carbon corrosion reaction (COR) and oxygen evolution reaction (OER) occurring in air-filled region 118 of electrolytic cell segment 130 may have a voltage reference of about 1.44 VRHE. The ΔE between fuel cell segment 128 and electrolytic cell segment 130 may be about 0.6 V. The ΔE across the anode compartment 102 and cathode compartment 104 may be about 0.84 V.

An air-air start of a PEMFC may occur when the PEMFC is not used over an extended period of time (e.g., over a weekend or longer), thereby allowing air to infiltrate into the PEMFC. During an air-air start of a PEMFC, hydrogen gas is introduced to the air-filled anode compartment. This results in a polarization of both electrodes of the PEMFC in the flow direction, whereby carbon corrosion may occur in the cathode electrode. What is needed are devices and methods for mitigating this polarization to mitigate cathode degradation during air-air start events.

The durability of a cathode catalyst layer in a PEMFC continues to be one of the main challenges for the widespread commercialization of PEMFCs for transportation and other applications. One of the main causes for degradation are air-air starts after extended shut-down periods. Under this scenario, a H₂/air gas front passes through the anode and causes a polarization of the anode between a hydrogen-filled anode segment, where the hydrogen oxidation reaction (HOR) takes place, and an air-filled anode segment, where the oxygen reduction reaction (ORR) occurs.

As these reactions occur within the same electrode with a high in-plane electrical conductivity and poor proton conductivity (e.g., insufficient for the in-plane conduction of protons over millimeter-scale distances), an oxidative current is forced on the segment of the cathode that is adjacent to the air-filled anode segment. This leads to a polarization of the cathode and cathode-sided carbon corrosion (COR) in the air-air filled segment of the cell.

In one or more embodiments, devices and methods for mitigating polarization of a cathode during air-air start events are disclosed, thereby mitigating overall cathode degradation. The source of the polarization may be a polarization of an anode from about 1 V in air to about 0 V in H₂ and limited proton conduction within the catalyst layers. In one or more configurations, the fuel stack dimensions may result in distances of 10 to 50 cm between an anode inlet and an anode outlet. This distance may cause a polarization of the anode electrode for at least a portion or the entire duration of a local residence time of a mixed gas composition within the anode compartment (e.g., 0.1 to 3 seconds), whereby the adjacent cathode at the anode outlet side is polarized to high oxidative potentials during this local event. One or more embodiments recognize that polarization may be mitigated by segmenting an anode flow field into a plurality of non-electrically interconnected segments to reduce degradation brought about by relatively good in-plane conductivity in the anode flow field. In one or more embodiments, by segmenting the anode compartment into a plurality of smaller and electrically isolated segments, polarization of the cathode is reduced, local event time is reduced, and/or air-air degradation is distributed more evenly throughout at least a portion and in some cases the entirety of the fuel cell.

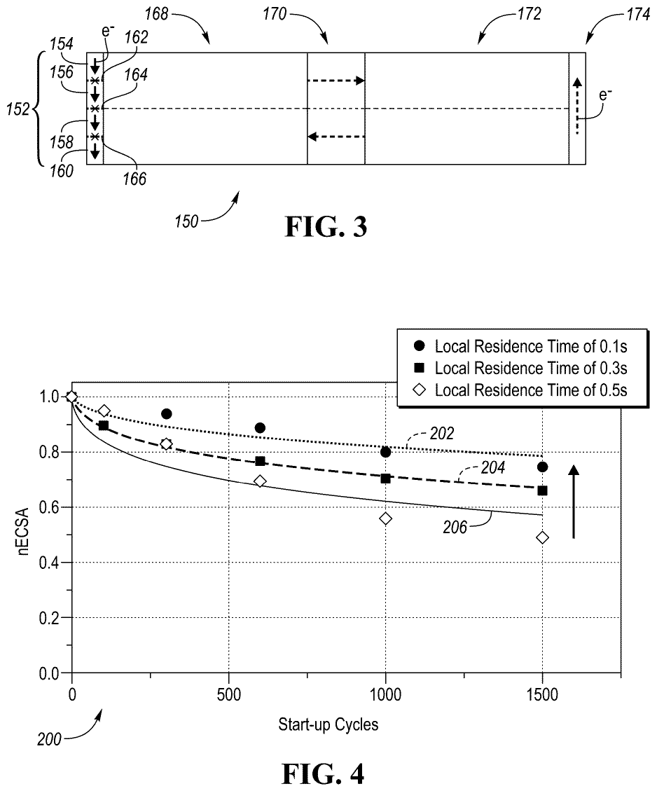

FIG. 3 depicts a schematic, side view of PEMFC 150 having segmented anode flow field 152 according to one embodiment. Anode flow field 152 may be formed of a bipolar plate having flow field channels. The anode flow field may be formed of stainless steel or other metal composite material (e.g., an iron-based composite material other than stainless steel, a titanium-based composite material, a nickel-based composite material, or an aluminum-based composite material). A metal composite anode flow field may be coated with a conductive coating (e.g., a graphitic material, a conductive metal, a conductive alloy, or a conductive composite material). The anode flow field may be formed of graphite or other graphitic material. PEMFC 150 includes anode compartment 168, cathode compartment 170, and PEM 172 extending between anode compartment 168 and cathode compartment 170. PEMFC 150 further includes cathode flow field 174.

As shown in FIG. 3, segmented anode flow field 152 has first, second, third, and fourth segments 154, 156, 158, and 160. First and second segments 154 and 156 are segmented by first separator 162. Second and third segments 156 and 158 are segmented by second separator 164. Third and fourth segments 158 and 160 are segmented by third separator 166. First, second, third separator 162, 164, and 166 are configured to significantly hinder electron and proton pathways between the first, second, third, and fourth segments 154, 156, 158, and 160. In one or more embodiments, the one or more separators extend the entire thickness of anode flow field 152. The one or more separators may be selectively formed as a pattern segmenting adjacent segments. The pattern may be a line.

When the anode flow field is formed of a metal composite material (e.g., stainless steel), one or more of the separators may be a semiconductor material separating regions of the flow field surface to form anode segments configured to limit in-plane conductivity of the anode flow field. In one or more embodiments, the flow field surface is structurally uninterrupted by the separating regions to maintain efficient flow patterns within the flow field. The semiconductor material may be titanium oxide, titanium carbide, titanium nitride, or a combination thereof. For a metal-based anode flow field, the one or more separators may be formed by a separator of non-conductive adhesive material (e.g., a polyurethane adhesive, a silicone-based adhesive, an acrylic-based adhesive, or a combination thereof). For a metal-based anode flow field, the one or more separators may be formed by selectively doping regions of the flow field (e.g., the entire thicknesses in the separator regions) to increase or decrease electrical conductivity of the regions. Non-limiting examples of dopants include metal dopants (e.g., tungsten (W), molybdenum (Mo), antimony (Sb), niobium (Nb), and chromium (Cr)) and non-metal dopants (e.g., nitrogen (N), fluorine (F), phosphorus (P), and sulfur(S)).

When the anode flow field is formed of a graphite-based material, one or more of the separators may be a carbon-epoxy composite material connecting the individual flow field segments configured to limit in-plane conductivity of the anode flow field. The carbon-epoxy composite material may be a carbon fiber-reinforced epoxy material, a graphite-epoxy composite, a carbon nanotube-epoxy composite, a carbon black-epoxy composite, or a combination thereof.

In one or more embodiments, the significant hinderance reduces the rate of one or more chemical reactions occurring during SUSD in PEMFC 150. The chemical reactions may include the HOR in the anode compartment (Reaction 1), the ORR in the anode compartment (Reaction 2), the ORR in the cathode compartment (Reaction 3), the COR in the cathode compartment (Reaction 4), and the OER in the cathode compartment (Reaction 5). The rate of one or more of these reactions may be reduced by any of the following percentage or in a range of any two of the following percentages: 50%, 55%, 60%, 65%, 70%, 75%, 80%, 85%, and 90%.

While the embodiment shown in FIG. 3 depicts four segments within the anode flow field, in other embodiments there may be less (e.g., 2 or 3) or more (e.g., 5, 6, 7, 8, 9, 10, 15, and 20) anode flow field segments. As shown in FIG. 3, the four segments have equal area on the anode flow field channel surface. In other embodiments, the segments may be varied in area.

In a segmented cell (e.g., PEMFC 150), a polarization may occur within each compartment (e.g., only within each compartment), which reduces the local event duration and/or the inhomogeneity of the degradation. These reductions may prolong the lifetime of the fuel cell stack.

In one or more embodiments, the fuel cell stack may include adjacent fuel cells having a flow field formed of a bipolar plate that combines an anode flow field and a cathode flow field of the adjacent fuel cell into an integrated structural component. The integrated structural component may be segmented into a plurality of electrically isolated segments. In one embodiment, where a fuel cell stack employs bipolar plates that have an anode flow field on one side and a cathode flow field on another side, each bipolar plate may be segmented, resulting in both anode and cathode flow fields being segments. In another embodiment, only every second bipolar plate is segments (e.g., 1, 3, 5, 7 . . . or 2, 4, 6, 8 . . . ) resulting in cells with alternating anode and cathode flow field being segmented with each cell having at least one flow field segmented.

FIG. 4 is graph 200 of normalized electrochemical surface area (nECSA) as a function of start-up cycles for different local residence times (i.e., 0.1 seconds, 0.3 seconds, and 0.5 seconds). FIG. 4 shows testing on subscale cells of 30 cm² to represent the process occurring in fuel cells in a fuel cell stack. FIG. 4 shows start-up aging curves 202, 204, and 206 for local residence times of 0.1 seconds, 0.3 seconds, and 0.5 seconds, respectively. As shown in FIG. 4, the nECSA, which is an important state of health indicator in a fuel cell, decays about 5 times slower upon reducing the local residence time from 0.5 seconds to 0.1 seconds. In one embodiment, a segmentation of the anode flow field in five (5) segmented compartments results in a similar reduction in degradation.

In another embodiment, one or more of the anode flow field, the anode electrode, and the anode GDL are segmented into segments to significantly hinder electron and proton pathways between the segments. Each of the segments may have any of the following number of segments or a range of any two of the following number of segments: 2, 3, 4, 5, 6, 7, 8, 9, 10, 15, and 20. In another embodiment, the cathode flow field is segmented to mitigate degradation during air-air start events.

In one embodiment, the segmentation is obtained by segmenting only the anode flow field. This may be considered a partial segmentation as the GDL (e.g., formed of a carbon fiber cloth) and the anode compartment may provide in-plane electron conductivity. However, the in-plane conductivity of the GDL may be significantly smaller than the in-plane conductivity of the anode flow field and the in-plane conductivity of the electrode may be smaller than the GDL in-plane conductivity. Significantly smaller may be any of the following X fold reductions in conductivity or in a range of any two of the following reductions: 2, 5, 10, 50, 100, 1,000, and 10,000. In one or more embodiments, the anode flow field and the GDL may both be segmented.

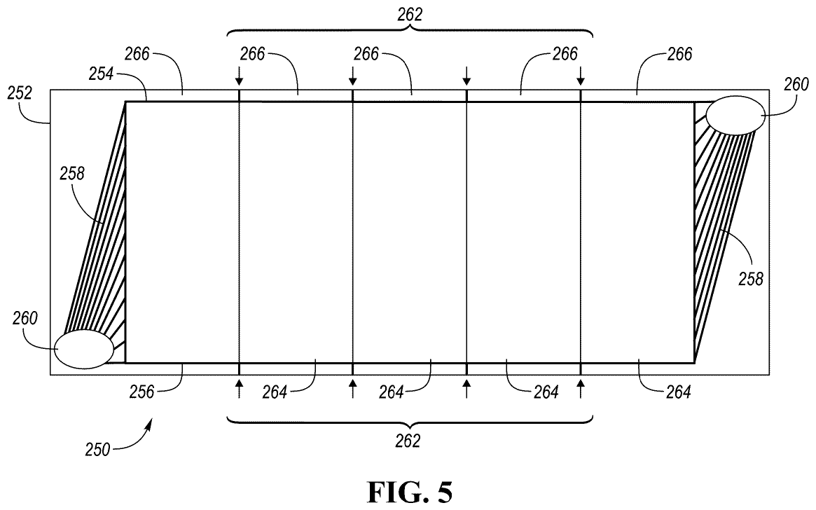

FIG. 5 depicts a schematic view of PEMFC 250 including segmented anode flow fields forming anode flow field segments and segmented GDLs forming GDL segments. PEMFC 250 includes anode flow field 252, GDL 254, liner 256, and anode gas channels 258 and manifold 260. In one or more embodiments, GDL 254 has a two-layer component structure including a microporous substrate and a microporous layer. The microporous structure may be formed from carbon fiber paper or carbon cloth. The microporous layer may be formed of a thin layer of carbon black mixed with a hydrophobic binder (e.g., polytetrafluoroethylene (PTFE)). Liner 256 may be formed of an electrically insulating material (e.g., PTFE). The components of GDL 254 may be mounted on liner 256 to form a GDL mounted liner construction that may be compressed to a thickness equal to or than the GDL layer thickness before compression.

GDL 254 may be segmented into segmentation layers 264 formed by segmented (e.g., non-continuous) deposition of the microporous layer on GDL 254 to form an electrically isolating structure to mitigate in-plane conductivity and gas transport to the electrodes of PEMFC 250. As shown in FIG. 5, GDL 254 includes conducting regions (i.e., segmentation layers 264) and insulating regions (i.e., liner 256). The conducting regions may have a conductivity (σ) of any of the following values or in a range of any two of the following values: 1, 10, 10², 10³, 10⁴, 10⁵, 10⁶, 10⁷, and 10⁸ S/m. The insulating regions may have a resistivity (ρ) of 1, 10, 10², 10³, 10⁴, 10⁵, 10⁶, 10⁷, and 10⁸, 10⁹, 10¹⁰, 10¹¹, 10¹², and 10¹³ Ω·m.

Anode flow field 252 is segmented with isolating segmentations 262 to form insulating regions and conducting segments 266 therebetween to form conducting regions where anode flow field 252 may be formed of a multi-component graphite polymer composite (e.g., graphite flakes or powder, a polymer matrix such as polypropylene, and optionally carbon black). In one or more embodiments, the insulating regions are rich in a resin material and the conducting regions are rich in graphite. The percentage of resin in the insulating region considered to be rich may be any of the following percentages or in a range of any two of the following percentages: 80%, 81%, 82%, 83%, 84%, 85%, 86%, 87%, 88%, 89%, 90%, 91%, 92%, 93%, 94%, 95%, 96%, 97%, 98%, and 99%. The percentage of graphite in the insulating region considered to be rich may be any of the following percentages or in a range of any two of the following percentages: 20%, 30%, 40%, 50%, 60%, 70%, 71%, 72%, 73%, 74%, 75%, 76%, 77%, 78%, 79%, 80%, 81%, 82%, 83%, 84%, 85%, 86%, 87%, 88%, 89%, and 90%.

The anode of PEMFC 250 may also be constructed of an electrically isolating structure including insulating regions and conducting regions as structured in the examples above for the anode flow field and anode GDL. In one or more embodiments, isolation of anode regions is achieved by having sections with anode and section without anode coating on a PEM. The anode thickness may be 100% of a nominal thickness in the conductive regions and between 0 to 50% anode thickness in the non-conductive regions (and 0 to 10% in certain embodiments). In another embodiment, there are regions of non-conductive filler material that is 10 to 100% of total anode material in these isolating regions.

The spacing and dimensions of the patterning of the insulating regions and the conducting regions for the anode electrode, anode flow field, and/or anode GDL may be selected based on gas flow, H₂/air front residence time, and/or one or more dimensions of the fuel cell stack. In one or more embodiments, the selection of segmentation patterning may be informed by an estimation of degradation per event, either collected from experimental data or modelling, as a function of these parameters. The dimensioning may also include segmentation patterns other than rectangles (e.g., circles, polygons other than rectangles, curved lines, serpentine shapes, etc.) to account for gas flow patterns.

While exemplary embodiments are described above with respect to PEMFCs, it is not intended that these embodiments describe all possible forms encompassed by the claims. For example, one or more embodiments of the high capacitance anodes disclosed herein may be applied to phosphoric acid fuel cells and/or electrochemical hydrogen pumps. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A fuel cell comprising:
a cathode electrode;
an anode electrode;
a membrane extending between the cathode electrode and the anode electrode;
a cathode gas diffusion layer (GDL);
a cathode flow field;
an anode GDL; and
an anode flow field segmented by one or more separators of the anode flow field channel to form a plurality of electrically isolating segments to mitigate polarization during an air-air start of the fuel cell.

2. The fuel cell of claim 1, wherein the anode flow field includes a metal composite material, and the one or more separators include a semiconductor material.

3. The fuel cell of claim 1, wherein the anode flow field includes a metal composite material, and the one or more separators include a non-conductive adhesive material.

4. The fuel cell of claim 1, wherein the anode flow field includes a graphite-based material, and the one or more separators include a carbon-epoxy composite material.

5. The fuel cell of claim 1, wherein the one or more separators are one or more selectively, spaced apart doped regions of the anode flow field.

6. The fuel cell of claim 1, wherein the one or more separators extend the thickness of the anode flow field.

7. The fuel cell of claim 1, wherein the plurality of electrically isolated segments is in a range of 2 to 10 electrically isolated segments.

8. The fuel cell of claim 1, wherein the one or more separators form insulating regions and the plurality of electrically isolated segments form conducting regions.

9. The fuel cell of claim 8, wherein the insulating regions include a resin material and the conducting regions include graphite.

10. The fuel cell of claim 8, wherein the conducting regions or the insulating regions have rectangular profiles.

11. A fuel cell comprising:
a cathode electrode;
an anode electrode;
a membrane extending between the cathode electrode and the anode electrode;
a cathode flow field;
a cathode gas diffusion layer (GDL);
an anode flow field;
an anode GDL having an electrically isolating structure to mitigate polarization during an air-air start of the fuel cell.

12. The fuel cell of claim 11, wherein the electrically isolating structure is an electrically insulating liner configured to mount the anode GDL.

13. The fuel cell of claim 12, wherein the electrically insulating liner includes polytetrafluoroethylene (PTFE).

14. The fuel cell of claim 11, wherein the electrically isolating structure includes conducting regions and insulating regions.

15. The fuel cell of claim 14, wherein the conducting regions or the insulating regions have rectangular profiles.

16. A fuel cell comprising:
a cathode electrode;
an anode electrode;
a membrane extending between the cathode electrode and the anode electrode;
a cathode flow field;
a cathode gas diffusion layer (GDL);
an anode flow field; and
an anode GDL,
the anode electrode has first regions and second regions different than the first regions to form a plurality of electrically isolated segments to mitigate polarization during an air-air start of the fuel cell.

17. The fuel cell of claim 16, wherein the first regions are insulating regions and the second regions are conducting regions.

18. The fuel cell of claim 16, wherein the first regions have a first solids content and the second regions have a second solids content greater than the second solids content.

19. The fuel cell of claim 17, wherein the conducting regions or the insulating regions have rectangular profiles.

20. A fuel cell stack comprising:
a first fuel cell including a first cathode electrode, a first anode electrode, a first membrane extending between the first cathode electrode and the first anode electrode, a first cathode gas diffusion layer (GDL), a first cathode flow field, a first anode GDL, and a first anode flow field; and
a second fuel cell including a second cathode electrode, a second anode electrode, a second membrane extending between the second cathode electrode and the second anode electrode, a second cathode GDL, a second anode GDL, and a second anode flow field adjacent to the first cathode flow field,
the second anode flow field and the first cathode flow field collectively form an integrated bipolar plate segmented by one or more segmentations extending at least a portion of the second anode flow field and the first cathode flow field to form a plurality of electrically isolated segments to mitigate polarization during an air-air start of the fuel cell stack.
